(19) United States
(12) Patent Application Publication
(10) Pub. No.: US 2026/0063467 A1
(43) Pub. Date: Mar. 5, 2026

(54) OPTIMIZATION DEVICE, OPTIMIZATION METHOD, AND NON-TRANSITORY COMPUTER-READABLE MEDIUM

(71) Applicant: NEC Corporation, Tokyo (JP)

(72) Inventors: Noriyuki TONAMI, Tokyo (JP); Yoshiyuki YAJIMA, Tokyo (JP); Sakiko MISHIMA, Tokyo (JP); Reishi KONDO, Tokyo (JP); Tomoyuki HINO, Tokyo (JP)

(73) Assignee: NEC Corporation, Tokyo (JP)

(21) Appl. No.: 19/294,366

(22) Filed: Aug. 8, 2025

(30) Foreign Application Priority Data
Aug. 27, 2024 (JP) 2024-145158

(51) Int. Cl. G01H 9/00

(52) U.S. Cl. CPC G01H 9/004

(57) ABSTRACT

An optimization device according to the present disclosure includes: at least one memory that stores a set of instructions; and at least one processor configured to execute the set of instructions, store in advance a plurality of first input/output pairs which are pairs of an input signal and an output signal of a machine learning model in a case where acoustic signals or vibration signals indicating a time-series change in acoustic waves or vibrations, which are observed through optical fiber sensing, are input to the machine learning model as input signals, in the at least one memory, and optimize an optimization target model using the plurality of first input/output pairs.

### INCORPORATION BY REFERENCE

This application is based upon and claims the benefit of priority from Japanese patent application No. 2024-145158, filed on Aug. 27, 2024, the disclosure of which is incorporated herein in its entirety by reference.

### TECHNICAL FIELD

The present disclosure relates to an optimization device, an optimization method, and a non-transitory computer-readable medium.

### BACKGROUND ART

Optical fiber sensing represented by distributed acoustic sensing (DAS) is a technology capable of observing acoustic waves and vibrations at a plurality of points along an optical fiber.

In recent years, a technology for training a machine learning model such as a deep learning model on acoustic signals or vibration signals indicating a time-series change in acoustic waves or vibrations observed through optical fiber sensing has been proposed. In this case, for example, a training target is an event occurring at a point along the optical fiber, noise components included in acoustic signals or vibration signals, or the like.

Here, the machine learning model such as the deep learning model is a nonlinear model trained on large-scale data. The machine learning model has a characteristic of having statistical knowledge obtained from large-scale data.

Therefore, in recent years, there has also been proposed a technology for optimizing an optimization target model by incorporating statistical knowledge possessed by the machine learning model into the model to be optimized. The optimization target model is, for example, a model to be optimized by using a mathematical optimization method or a machine learning model. For example, WO 2022/250053 A1 discloses a technology for training a neural process model, which is a deep learning model, to be an optimization target model.

### SUMMARY

However, while the machine learning model has a characteristic of having statistical knowledge, the machine learning model also has a characteristic of having a high computational amount. Therefore, in the optimization method as disclosed in WO 2022/250053 A1, there is a problem that the computational amount for optimizing the optimization target model increases.

In view of the above-described problems, an example object of the present disclosure is to provide an optimization device capable of reducing the computational amount for optimizing an optimization target model, an optimization method, and a non-transitory computer-readable medium.

According to an example aspect of the present disclosure, there is provided an optimization device including:
at least one memory that stores a set of instructions; and
at least one processor configured to
execute the set of instructions,
store in advance a plurality of first input/output pairs which are pairs of an input signal and an output signal of a machine learning model in a case where acoustic signals or vibration signals indicating a time-series change in acoustic waves or vibrations, which are observed through optical fiber sensing, are input to the machine learning model as input signals, in the at least one memory, and
optimize an optimization target model using the plurality of first input/output pairs.

According to another example aspect of the present disclosure, there is provided an optimization method executed by an optimization device, the method including:
storing in advance a plurality of first input/output pairs which are pairs of an input signal and an output signal of a machine learning model in a case where acoustic signals or vibration signals indicating a time-series change in acoustic waves or vibrations, which are observed through optical fiber sensing, are input to the machine learning model as input signals; and
optimizing an optimization target model using the plurality of first input/output pairs.

According to still another example aspect of the present disclosure, there is provided a non-transitory computer-readable medium storing a program that causes a computer to execute:
a procedure of storing in advance a plurality of first input/output pairs which are pairs of an input signal and an output signal of a machine learning model in a case where acoustic signals or vibration signals indicating a time-series change in acoustic waves or vibrations, which are observed through optical fiber sensing, are input to the machine learning model as input signals; and
a procedure of optimizing an optimization target model using the plurality of first input/output pairs.

According to the aspects described above, it is possible to provide an optimization device capable of reducing the computational amount for optimizing an optimization target model, an optimization method, and a non-transitory computer-readable medium.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating a concept of an optimization device according to the present disclosure;

FIG. 2 is a block diagram illustrating a schematic configuration example of an optimization device according to the present disclosure;

FIG. 3 is a diagram illustrating a schematic operation example of an optimization device according to the present disclosure;

FIG. 4 is a flowchart illustrating an example of an operation flow in step S11 in FIG. 3;

FIG. 5 is a diagram illustrating an effect of an optimization device according to the present disclosure;

FIG. 6 is a diagram illustrating a concept of an optimization device according to the present disclosure;

FIG. 7 is a block diagram illustrating a schematic configuration example of an optimization device according to the present disclosure;

FIG. 8 is a diagram illustrating a schematic operation example of an optimization device according to the present disclosure;

FIG. 9 is a flowchart illustrating an example of an operation flow in step S21 in FIG. 8;

FIG. 10 is a block diagram illustrating a schematic configuration example of an optimization device according to the present disclosure; and

FIG. 11 is a block diagram illustrating a schematic hardware configuration example of a computer that implements an optimization device according to the present disclosure.

### EXAMPLE EMBODIMENTS

Example embodiments of the present disclosure are described below with reference to the drawings. The following description and drawings are omitted and simplified as appropriate for clarity of description. In the following drawings, the same elements will be denoted by the same reference signs, and redundant description will be omitted as necessary.

### First Example Embodiment

First, a concept of a first example embodiment will be described.

FIG. 1 is a diagram illustrating a concept of an optimization device 10 according to the present disclosure.

As illustrated in FIG. 1, the optimization device 10 is a device that optimizes a model 20 by incorporating statistical knowledge possessed by a machine learning model (hereinafter, for convenience, referred to as a machine learning model M) such as a deep learning model into an optimization target model 20.

Here, the machine learning model M is a trained model that is trained using, as input signals, acoustic signals or vibration signals indicating a time-series change in acoustic waves or vibrations occurring at a point along an optical fiber, the acoustic signals or vibration signals being observed through optical fiber sensing represented by DAS.

For example, the machine learning model M is a trained model that is trained to learn a relationship between an acoustic signal or a vibration signal and text by using the acoustic signals or the vibration signals as input signals. In this case, the text is text indicating an event occurring at a point along the optical fiber. In this case, the output signal of the machine learning model M is text, or a set of the acoustic signal or the vibration signal and the text.

The machine learning model M is a trained model that is trained to learn noise components included in the acoustic signals or the vibration signals by using the acoustic signals or the vibration signals as input signals. In this case, the output signal of the machine learning model M is a signal in which noise is suppressed from the acoustic signals or the vibration signals.

In the following description, for convenience of description, the input signal of the machine learning model M will be described as an acoustic signal indicating a time-series change in acoustic waves occurring at a point along the optical fiber, the acoustic signal being observed through optical fiber sensing.

The optimization device 10 includes an input/output storage 11. The input/output storage 11 stores in advance a plurality of input/output pairs (first input/output pairs) {(Iₖ, Oₖ)}_{k=1˜K} which are pairs of an input signal and an output signal of the machine learning model M in a case where the acoustic signals are input to the machine learning model M as input signals. Note that “k=1˜K” is the same meaning as “k=1 to K”. Here, an input/output pair of the machine learning model M in a case where the k-th (k=1˜K) acoustic signal is input to the machine learning model M is represented by (Iₖ, Oₖ).

By using a plurality of input/output pairs {(Iₖ, Oₖ)}_{k=1˜K}, the optimization device 10 optimizes the model 20 while evaluating likelihood indicating whether an output signal y of the model 20 in a case where an input signal x, which is an acoustic signal, is input to the model 20 is likely (whether the output signal y is close to a solution to be obtained).

Next, a configuration of the first example embodiment will be described.

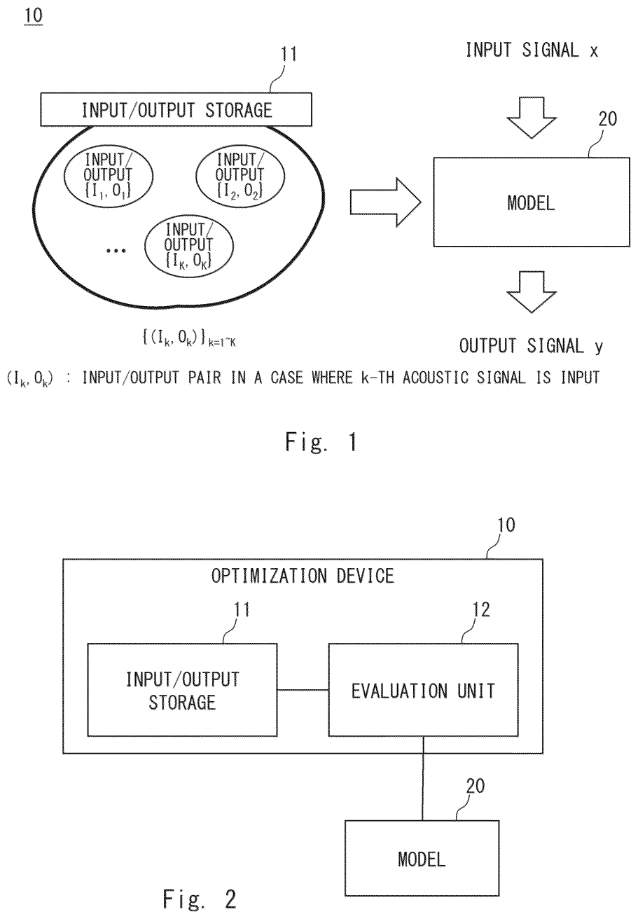

FIG. 2 is a block diagram illustrating a schematic configuration example of the optimization device 10 according to the present disclosure.

As illustrated in FIG. 2, the optimization device 10 includes the input/output storage 11 and an evaluation unit 12.

As described above, the input/output storage 11 stores a plurality of input/output pairs {(Iₖ, Oₖ)}_{k=1˜K} in advance.

The evaluation unit 12 optimizes the optimization target model 20 using a plurality of input/output pairs {(Iₖ, Oₖ)}_{k=1˜K}. Specifically, by using the plurality of input/output pairs {(Iₖ, Oₖ)}_{k=1˜K}, the evaluation unit 12 optimizes the model 20 while evaluating the likelihood of the output signal y of the model 20 in a case where the input signal x, which is an acoustic signal, is input to the model 20.

Next, the operation of the first example embodiment will be described.

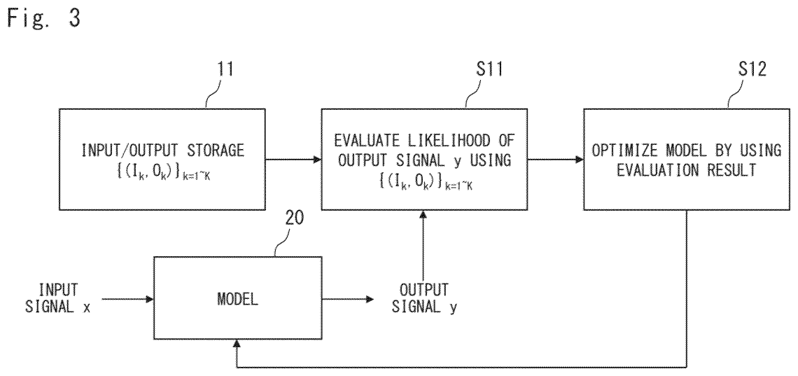

FIG. 3 is a diagram illustrating a schematic operation example of the optimization device 10 according to the present disclosure. In FIG. 3, a plurality of input/output pairs {(Iₖ, Oₖ)}_{k=1˜K} are already stored in the input/output storage 11. The output signal y of the model 20 in a case where the input signal x, which is an acoustic signal, is input to the model 20 is already obtained.

As illustrated in FIG. 3, first, by using the plurality of input/output pairs {(Iₖ, Oₖ)}_{k=1˜K}, the evaluation unit 12 evaluates the likelihood of the output signal y of the model 20 in a case where the input signal x, which is an acoustic signal, is input to the model 20 (step S11).

Next, the evaluation unit 12 optimizes the model 20 by using the result of evaluating the likelihood of the output signal y of the model 20 (step S12). For example, in a case where the likelihood “one” is the best result, the evaluation unit 12 optimizes the model 20 by updating the parameters of the model 20 in such a way that the likelihood of the output signal y approaches “one”.

Here, the operation in step S11 in FIG. 3 will be described in detail.

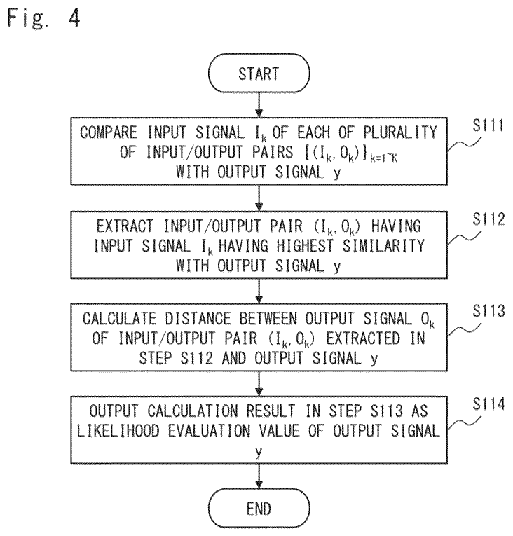

FIG. 4 is a flowchart illustrating an example of an operation flow in step S11 in FIG. 3.

As illustrated in FIG. 4, first, the evaluation unit 12 compares an input signal Iₖ of each of a plurality of input/output pairs {(Iₖ, Oₖ)}_{k=1˜K} with the output signal y of the model 20 (step S111).

Next, the evaluation unit 12 extracts an input/output pair (Iₖ, Oₖ) having an input signal Iₖ having the highest similarity with the output signal y of the model 20 from the plurality of input/output pairs {(Iₖ, Oₖ)}_{k=1˜K} (step S112).

Next, the evaluation unit 12 calculates a distance between an output signal Oₖ of the input/output pair (Iₖ, Oₖ) extracted in step S112 and the output signal y of the model 20 (step S113).

Thereafter, the evaluation unit 12 outputs the calculation result in step S113 as a likelihood evaluation value of the output signal y of the model 20 (step S114).

That is, the evaluation unit 12 evaluates that as the output signal y of the model 20 and the output signal Oₖ of the input/output pair (Iₖ, Oₖ) extracted in step S112 are closer, the output signal y of the model 20 is more likely.

According to the first example embodiment as described above, the input/output storage 11 stores in advance a plurality of input/output pairs {(Iₖ, Oₖ)}_{k=1˜K} which are pairs of an input signal and an output signal of the machine learning model M in a case where the acoustic signals are input to the machine learning model M as input signals. The evaluation unit 12 optimizes the optimization target model 20 using a plurality of input/output pairs {(Iₖ, Oₖ)}_{k=1˜K}.

As described above, since the plurality of input/output pairs {(Iₖ, Oₖ)}_{k=1˜K} of the input signal and the output signal of the machine learning model M are stored in advance, in optimizing the optimization target model 20, the model 20 is only required to be optimized using a necessary input/output pair (Iₖ, Oₖ) among the plurality of input/output pairs {(Iₖ, Oₖ)}_{k=1˜K}. Thus, it is possible to reduce the computational amount for optimizing the model 20.

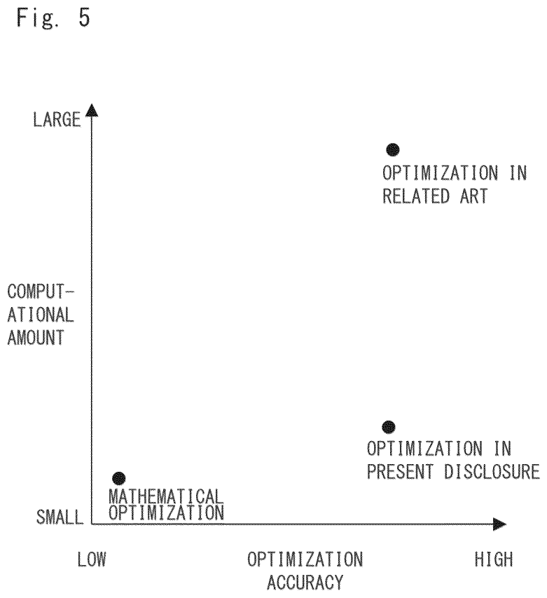

FIG. 5 is a diagram illustrating an effect of the optimization device 10 according to the present disclosure. In FIG. 5, the horizontal axis represents the optimization accuracy, which is the accuracy of the optimized model 20, and the optimization accuracy increases the direction approaches the positive direction. The vertical axis represents a computational amount required for optimization of the model 20, and the computational amount increases as the direction approaches the positive direction. FIG. 5 also illustrates, for comparison, the optimization accuracy and the computational amount in a case where the model 20 is optimized by the mathematical optimization method and in a case where the model 20 is optimized in the related art. The optimization method of the model 20 in the related art is, for example, a method for training the model 20 on the machine learning model M as in WO 2022/250053 A1.

As illustrated in FIG. 5, in the optimization method by the optimization device 10, since the statistical knowledge possessed by the machine learning model M can be incorporated into the model 20, it is possible to achieve the same optimization accuracy as that of the optimization method in the related art.

On the other hand, in the optimization method by the optimization device 10, a plurality of input/output pairs of the input signal and the output signal of the machine learning model M are stored in advance. Therefore, the computational amount required for optimization can be reduced to the computational amount equivalent to that of the mathematical optimization method.

### Second Example Embodiment

First, a concept of a second example embodiment will be described.

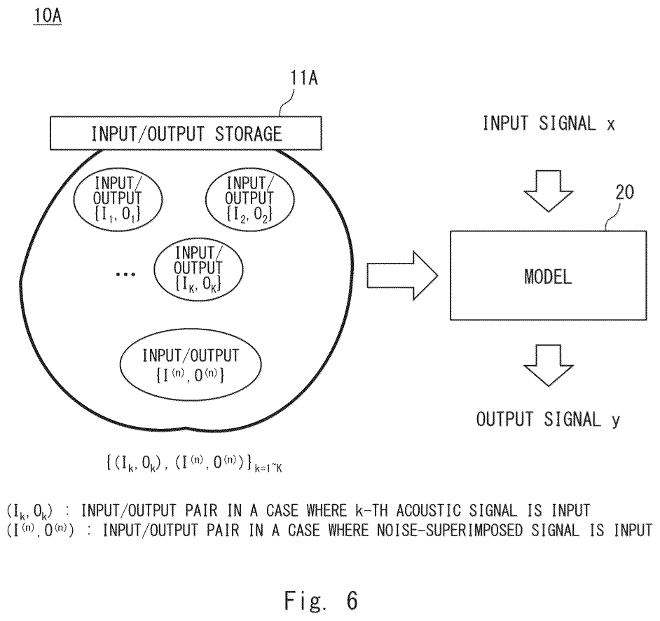

FIG. 6 is a diagram illustrating a concept of an optimization device 10A according to the present disclosure.

As illustrated in FIG. 6, similarly to the optimization device 10, the optimization device 10A is a device that optimizes the model 20 by incorporating statistical knowledge possessed by the machine learning model M into the optimization target model 20.

However, in the second example embodiment, the machine learning model M is a trained model that is trained to learn noise components included in the acoustic signals or the vibration signals by using the acoustic signals or the vibration signals, which are observed through the optical fiber sensing, as input signals. The output signal of the machine learning model M is a signal in which noise is suppressed from the input signals which are the acoustic signals or the vibration signals.

In the following description, for convenience of description, the input signal of the machine learning model M will be described as an acoustic signal indicating a time-series change in acoustic waves occurring at a point along the optical fiber, the acoustic signal being observed through optical fiber sensing.

The optimization device 10A includes an input/output storage 11A. Similarly to the input/output storage 11, the input/output storage 11A stores a plurality of input/output pairs {(Iₖ, Oₖ)}_{k=1˜K} in advance. In addition, the input/output storage 11A stores in advance an input/output pair (second input/output pair) (I⁽ⁿ⁾, O⁽ⁿ⁾) which is a pair of an input signal and an output signal of the machine learning model M in a case where the acoustic signals, which are noise-superimposed signals on which noise is superimposed, are input to the machine learning model M as input signals.

By using a plurality of input/output pairs {(Iₖ, Oₖ)}_{k=1˜K} and an input/output pair (I⁽ⁿ⁾, O⁽ⁿ⁾), the optimization device 10A optimizes the model 20 while evaluating likelihood indicating whether an output signal y of the model 20 in a case where an input signal x, which is an acoustic signal, is input to the model 20 is likely (whether the output signal y is close to a solution to be obtained).

Next, a configuration of the second example embodiment will be described.

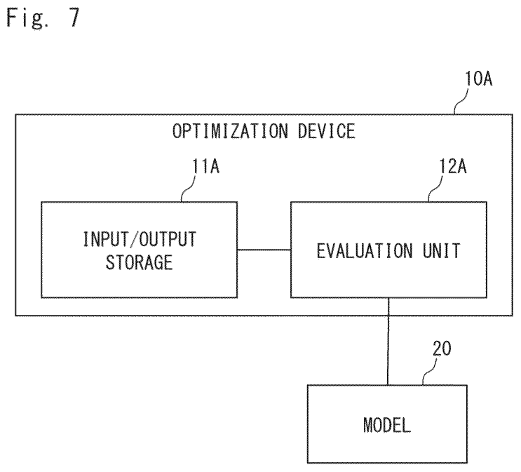

FIG. 7 is a block diagram illustrating a schematic configuration example of the optimization device 10A according to the present disclosure.

As illustrated in FIG. 7, the optimization device 10A includes the input/output storage 11A and an evaluation unit 12A.

As described above, the input/output storage 11A stores a plurality of input/output pairs {(Iₖ, Oₖ)}_{k=1˜K} in advance, and stores an input/output pair (I⁽ⁿ⁾, O⁽ⁿ⁾) in advance.

The evaluation unit 12A optimizes the optimization target model 20 using the plurality of input/output pairs {(Iₖ, Oₖ)}_{k=1˜K} and the input/output pair (I⁽ⁿ⁾, O⁽ⁿ⁾). Specifically, by using the plurality of input/output pairs {(Iₖ, Oₖ)}_{k=1˜K} and the input/output pair (I⁽ⁿ⁾, O⁽ⁿ⁾), the evaluation unit 12A optimizes the model 20 while evaluating the likelihood of the output signal y of the model 20 in a case where the input signal x, which is an acoustic signal, is input to the model 20.

Next, the operation of the second example embodiment will be described.

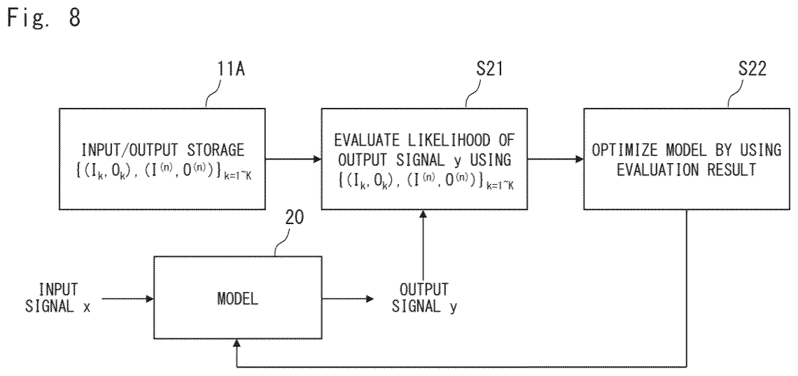

FIG. 8 is a diagram illustrating a schematic operation example of the optimization device 10A according to the present disclosure. In FIG. 8, a plurality of input/output pairs {(Iₖ, Oₖ)}_{k=1˜K} and an input/output pair (I⁽ⁿ⁾, O⁽ⁿ⁾) are already stored in the input/output storage 11A.

The output signal y of the model 20 in a case where the input signal x, which is an acoustic signal, is input to the model 20 is already obtained.

As illustrated in FIG. 8, first, by using the plurality of input/output pairs {(Iₖ, Oₖ)}_{k=1˜K} and the input/output pair (I⁽ⁿ⁾, O⁽ⁿ⁾), the evaluation unit 12A evaluates the likelihood of the output signal y of the model 20 in a case where the input signal x, which is an acoustic signal, is input to the model 20 (step S21).

Next, the evaluation unit 12A optimizes the model 20 by using the result of evaluating the likelihood of the output signal y of the model 20 (step S22). For example, in a case where the likelihood “one” is the best result, the evaluation unit 12A optimizes the model 20 by updating the parameters of the model 20 in such a way that the likelihood of the output signal y approaches “one”.

Here, the operation in step S21 in FIG. 8 will be described in detail.

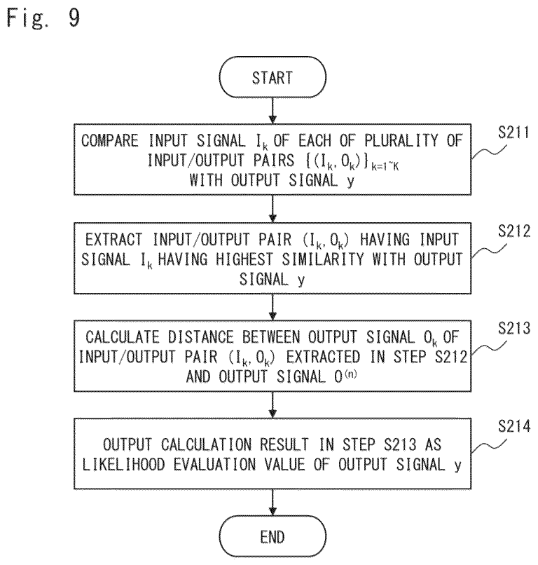

FIG. 9 is a flowchart illustrating an example of an operation flow in step S21 in FIG. 8.

As illustrated in FIG. 9, first, the evaluation unit 12A performs processing in steps S211 and S212 similar to steps S111 and S112 in FIG. 4 is performed. Thus, the evaluation unit 12A extracts an input/output pair (Iₖ, Oₖ) having an input signal Iₖ having the highest similarity with the output signal y of the model 20 from the plurality of input/output pairs {(Iₖ, Oₖ)}_{k=1˜K}.

Next, the evaluation unit 12A calculates a distance between an output signal Oₖ of the input/output pair (Iₖ, Oₖ) extracted in step S212 and an output signal O⁽ⁿ⁾ of the input/output pair (I⁽ⁿ⁾, O⁽ⁿ⁾) (step S213).

Thereafter, the evaluation unit 12A outputs the calculation result in step S213 as a likelihood evaluation value of the output signal y of the model 20 (step S214).

That is, the evaluation unit 12A evaluates that the output signal Oₖ of the input/output pair (Iₖ, Oₖ) extracted in step S212 and the output signal O⁽ⁿ⁾ of the input/output pair (I⁽ⁿ⁾, O⁽ⁿ⁾) are closer, the output signal y of the model 20 is more likely.

As described above, according to the second example embodiment, the machine learning model M is a trained model that is trained to learn noise components included in the acoustic signals or the vibration signals by using the acoustic signals or the vibration signals as input signals, and the output signal of the machine learning model M is a signal in which noise is suppressed from the acoustic signals or the vibration signals. Under this assumption, the input/output storage 11A stores in advance a plurality of input/output pairs {(Iₖ, Oₖ)}_{k=1˜K} which are pairs of an input signal and an output signal of the machine learning model M in a case where the acoustic signals are input to the machine learning model M as input signals, and stores in advance an input/output pair (I⁽ⁿ⁾, O⁽ⁿ⁾), which is a pair of an input signal and an output signal of the machine learning model M in a case where the acoustic signals, which are noise-superimposed signals on which noise is superimposed, are input to the machine learning model M as input signals. The evaluation unit 12A optimizes the optimization target model 20 using the plurality of input/output pairs {(Iₖ, Oₖ)}_{k=1˜K} and the input/output pair (I⁽ⁿ⁾, O⁽ⁿ⁾ ).

As described above, since the plurality of input/output pairs {(Iₖ, Oₖ)}_{k=1˜K} and the input/output pair (I⁽ⁿ⁾, O⁽ⁿ⁾ ) of the input signal and the output signal of the machine learning model M are stored in advance, in optimizing the optimization target model 20, the model 20 is only required to be optimized using a necessary input/output pair (Iₖ, Oₖ) among the plurality of input/output pairs {(Iₖ, Oₖ)}_{k=1˜K} and the input/output pair (I⁽ⁿ⁾, O⁽ⁿ⁾). Thus, it is possible to reduce the computational amount for optimizing the model 20. Since the statistical knowledge possessed by the machine learning model M can be incorporated into the model 20, it is possible to suppress noise of the input signal that is an acoustic signal by using the model 20.

### Third Example Embodiment

The third example embodiment corresponds to an example embodiment that generalizes the first and second example embodiments described above.

FIG. 10 is a block diagram illustrating a schematic configuration example of an optimization device 10B according to the present disclosure.

As illustrated in FIG. 10, the optimization device 10B includes a storage unit 11B and an evaluation unit 12B.

The storage unit 11B stores in advance a plurality of first input/output pairs which are pairs of an input signal and an output signal of the machine learning model M in a case where the acoustic signals or the vibration signals indicating a time-series change in acoustic waves or vibrations, which are observed through optical fiber sensing, are input to the machine learning model M as input signals.

The evaluation unit 12B optimizes the optimization target model 20 using the plurality of first input/output pairs.

As described above, since a plurality of input/output pairs of the input signal and the output signal of the machine learning model M are stored in advance, in optimizing the optimization target model 20, the model 20 is only required to be optimized using a necessary input/output pair among the plurality of input/output pairs. Thus, it is possible to reduce the computational amount for optimizing the model 20.

The evaluation unit 12B may compare the input signal of each of the plurality of first input/output pairs with the output signal of the model 20 in a case where the acoustic signals or the vibration signals are input to the optimization target model 20 as the input signals, and extract the first input/output pair having the input signal having the highest similarity with the output signal of the model 20 from the plurality of first input/output pairs. The evaluation unit 12B may evaluate the likelihood of the output signal of the model 20 using the output signal of the extracted first input/output pair and the output signal of the model 20, and optimize the model 20 using the result of evaluating the likelihood.

The machine learning model M may be a model that is trained to learn a relationship between an acoustic signal or a vibration signal and text by using the acoustic signals or the vibration signals as input signals.

The output signal of the machine learning model M may be text, or a set of the acoustic signal or the vibration signal and the text.

The machine learning model M may be a model that is trained to learn noise components included in the acoustic signals or the vibration signals by using the acoustic signals or the vibration signals as input signals.

The output signal of the machine learning model M may be a signal in which noise is suppressed from the input signals which are the acoustic signals or the vibration signals.

The storage unit 11B may further store in advance a second input/output pair which is a pair of an input signal and an output signal of the machine learning model M in a case where the acoustic signals or the vibration signals, on which noise is superimposed, are input to the machine learning model M as input signals.

The evaluation unit 12B may compare the input signal of each of the plurality of first input/output pairs with the output signal of the model 20 in a case where the acoustic signals or the vibration signals are input to the optimization target model 20 as the input signals, and extract the first input/output pair having the input signal having the highest similarity with the output signal of the model 20 from the plurality of first input/output pairs. The evaluation unit 12B may evaluate the likelihood of the output signal of the model 20 using the output signal of the extracted first input/output pair and the output signal of the second input/output pair, and optimize the model 20 using the result of evaluating the likelihood.

### Hardware Configuration of Optimization Device

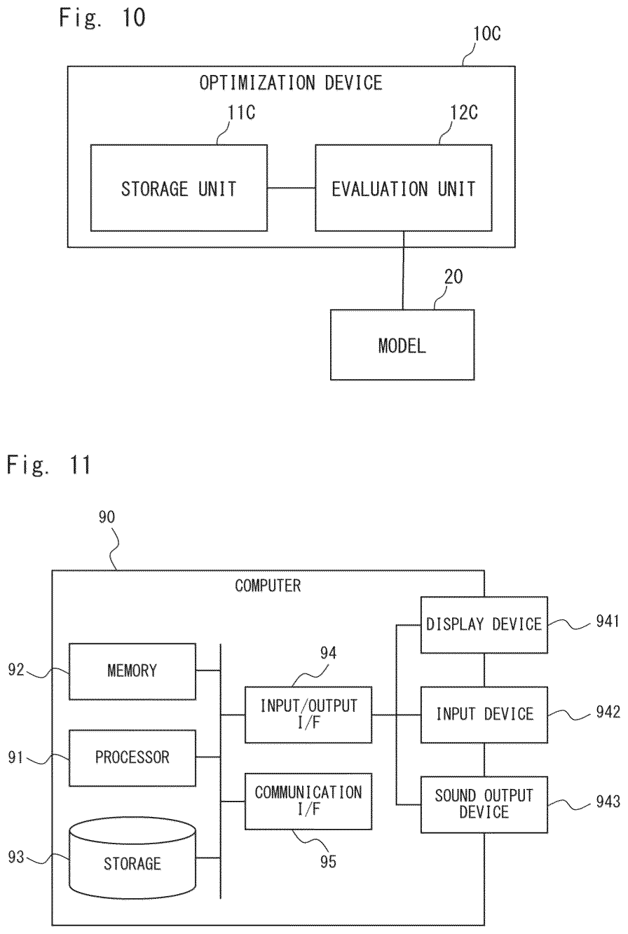

FIG. 11 is a block diagram illustrating a schematic hardware configuration example of a computer 90 that implements the optimization devices 10, 10A, and 10B.

As shown in FIG. 11, the computer 90 includes a processor 91, a memory 92, a storage 93, an input/output interface (input/output I/F) 94, and a communication interface (communication I/F) 95. The processor 91, the memory 92, the storage 93, the input/output interface 94, and the communication interface 95 are connected by a data transmission path for mutually transmitting and receiving data.

The processor 91 is, for example, an arithmetic processing device such as a central processing unit (CPU) or a graphics processing unit (GPU). The memory 92 is, for example, a memory such as a random access memory (RAM) or a read only memory (ROM). The storage 93 is, for example, a storage device such as a hard disk drive (HDD), a solid state drive (SSD), or a memory card. The storage 93 may be a memory such as the RAM or the ROM.

A program is stored in the storage 93. This program includes a set of instructions (or software code) for causing the computer 90 to perform one or more functions of the optimization devices 10, 10A, and 10B described above in a case where the program is read by the computer. The components in the above-described optimization devices 10, 10A, and 10B may be implemented by the processor 91 reading and executing a program stored in the storage 93. The storage functions in the optimization devices 10, 10A, and 10B described above may be implemented by the memory 92 or the storage 93.

Further, the above-described program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The input/output interface 94 is connected to a display device 941, an input device 942, a sound output device 943, and the like. The display device 941 is a device that displays a screen corresponding to drawing data processed by the processor 91, such as a liquid crystal display (LCD), a cathode ray tube (CRT) display, or a monitor. The input device 942 is a device that receives operator's operation input, and is, for example, a keyboard, a mouse, a touch sensor, or the like. The display device 941 and the input device 942 may be integrated and implemented as a touch panel. The sound output device 943 is a device that acoustically outputs a sound corresponding to acoustic data processed by the processor 91, such as a speaker.

The communication interface 95 transmits and receives data to and from an external device. For example, the communication interface 95 communicates with an external device via a wired communication path or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### Supplementary Note 1

An optimization device including:
at least one memory that stores a set of instructions; and
at least one processor configured to
execute the set of instructions,
store in advance a plurality of first input/output pairs which are pairs of an input signal and an output signal of a machine learning model in a case where acoustic signals or vibration signals indicating a time-series change in acoustic waves or vibrations, which are observed through optical fiber sensing, are input to the machine learning model as input signals, in the at least one memory, and
optimize an optimization target model using the plurality of first input/output pairs.

### Supplementary Note 2

The optimization device according to Supplementary Note 1,
in which the at least one processor is configured to:
compare an input signal of each of the plurality of first input/output pairs with an output signal of the optimization target model in a case where the acoustic signals or the vibration signals are input to the optimization target model as the input signals;
extract a first input/output pair having an input signal having a highest similarity with the output signal of the optimization target model from the plurality of first input/output pairs;
evaluate likelihood of the output signal of the optimization target model using the output signal of the extracted first input/output pair and the output signal of the optimization target model; and
optimize the optimization target model using a result of evaluating the likelihood.

### Supplementary Note 3

The optimization device according to Supplementary Note 1, in which the machine learning model is a model that is trained to learn a relationship between each of the acoustic signals or each of the vibration signals and text by using the acoustic signals or the vibration signals as the input signals.

### Supplementary Note 4

The optimization device according to Supplementary Note 3, in which the output signal of the machine learning model is the text or a set of the acoustic signal or the vibration signal and the text.

### Supplementary Note 5

The optimization device according to Supplementary Note 1, in which the machine learning model is a model that is trained to learn noise components included in the acoustic signals or the vibration signals using the acoustic signals or the vibration signals as the input signals.

### Supplementary Note 6

The optimization device according to Supplementary Note 5, in which the output signal of the machine learning model is a signal in which noise is suppressed from the input signals that are the acoustic signals or the vibration signals.

### Supplementary Note 7

The optimization device according to Supplementary Note 6, in which the at least one processor is configured to further store in advance a second input/output pair that is a pair of an input signal and an output signal of the machine learning model in a case where the acoustic signals or the vibration signals, on which noise is superimposed, are input to the machine learning model as input signals, in the at least one memory.

### Supplementary Note 8

The optimization device according to Supplementary Note 7,
in which the at least one processor is configured to:
compare an input signal of each of the plurality of first input/output pairs with an output signal of the optimization target model in a case where the acoustic signals or the vibration signals are input to the optimization target model as the input signals;
extract a first input/output pair having an input signal having a highest similarity with the output signal of the optimization target model from the plurality of first input/output pairs;
evaluate likelihood of the output signal of the optimization target model using an output signal of the extracted first input/output pair and an output signal of the second input/output pair; and
optimize the optimization target model using a result of evaluating the likelihood.

### Supplementary Note 9

An optimization method executed by an optimization device, the method including:
storing in advance a plurality of first input/output pairs which are pairs of an input signal and an output signal of a machine learning model in a case where acoustic signals or vibration signals indicating a time-series change in acoustic waves or vibrations, which are observed through optical fiber sensing, are input to the machine learning model as input signals; and
optimizing an optimization target model using the plurality of first input/output pairs.

### Supplementary Note 10

A non-transitory computer-readable medium storing a program that causes a computer to execute:
a procedure of storing in advance a plurality of first input/output pairs which are pairs of an input signal and an output signal of a machine learning model in a case where acoustic signals or vibration signals indicating a time-series change in acoustic waves or vibrations, which are observed through optical fiber sensing, are input to the machine learning model as input signals; and
a procedure of optimizing an optimization target model using the plurality of first input/output pairs.

Note that, some or all of elements (e.g., structures and functions) specified in Supplementary Notes 2 to 8 dependent on Supplementary Note 1 may also be dependent on Supplementary Notes 9 and 10 in dependency similar to that of Supplementary Notes 2 to 8dependent on Supplementary Note 1. Some or all of elements specified in any of Supplementary Notes may be applied to various types of hardware, software, and recording means for recording software, systems, and methods.

What is claimed is:

1. An optimization device comprising:
at least one memory that stores a set of instructions; and
at least one processor configured to
execute the set of instructions,
store in advance a plurality of first input/output pairs which are pairs of an input signal and an output signal of a machine learning model in a case where acoustic signals or vibration signals indicating a time-series change in acoustic waves or vibrations, which are observed through optical fiber sensing, are input to the machine learning model as input signals, in the at least one memory, and
optimize an optimization target model using the plurality of first input/output pairs.

2. The optimization device according to claim 1,
wherein the at least one processor is configured to:
compare an input signal of each of the plurality of first input/output pairs with an output signal of the optimization target model in a case where the acoustic signals or the vibration signals are input to the optimization target model as the input signals;
extract a first input/output pair having an input signal having a highest similarity with the output signal of the optimization target model from the plurality of first input/output pairs;
evaluate likelihood of the output signal of the optimization target model using the output signal of the extracted first input/output pair and the output signal of the optimization target model; and
optimize the optimization target model using a result of evaluating the likelihood.

3. The optimization device according to claim 1, wherein the machine learning model is a model that is trained to learn a relationship between each of the acoustic signals or each of the vibration signals and text by using the acoustic signals or the vibration signals as the input signals.

4. The optimization device according to claim 3, wherein the output signal of the machine learning model is the text or a set of the acoustic signal or the vibration signal and the text.

5. The optimization device according to claim 1, wherein the machine learning model is a model that is trained to learn noise components included in the acoustic signals or the vibration signals using the acoustic signals or the vibration signals as the input signals.

6. The optimization device according to claim 5, wherein the output signal of the machine learning model is a signal in which noise is suppressed from the input signals that are the acoustic signals or the vibration signals.

7. The optimization device according to claim 6, wherein the at least one processor is configured to further store in advance a second input/output pair that is a pair of an input signal and an output signal of the machine learning model in a case where the acoustic signals or the vibration signals, on which noise is superimposed, are input to the machine learning model as input signals, in the at least one memory.

8. The optimization device according to claim 7,
wherein the at least one processor is configured to:
compare an input signal of each of the plurality of first input/output pairs with an output signal of the optimization target model in a case where the acoustic signals or the vibration signals are input to the optimization target model as the input signals;
extract a first input/output pair having an input signal having a highest similarity with the output signal of the optimization target model from the plurality of first input/output pairs;
evaluate likelihood of the output signal of the optimization target model using an output signal of the extracted first input/output pair and an output signal of the second input/output pair; and
optimize the optimization target model using a result of evaluating the likelihood.

9. An optimization method executed by an optimization device, the method comprising:
storing in advance a plurality of first input/output pairs which are pairs of an input signal and an output signal of a machine learning model in a case where acoustic signals or vibration signals indicating a time-series change in acoustic waves or vibrations, which are observed through optical fiber sensing, are input to the machine learning model as input signals; and
optimizing an optimization target model using the plurality of first input/output pairs.

10. A non-transitory computer-readable medium storing a program that causes a computer to execute:
a procedure of storing in advance a plurality of first input/output pairs which are pairs of an input signal and an output signal of a machine learning model in a case where acoustic signals or vibration signals indicating a time-series change in acoustic waves or vibrations, which are observed through optical fiber sensing, are input to the machine learning model as input signals; and
a procedure of optimizing an optimization target model using the plurality of first input/output pairs.
